(19) United States
(12) Patent Application Publication
(10) Pub. No.: US 2024/0248700 A1
(43) Pub. Date: Jul. 25, 2024

(54) PARENT-CHILD GPU FIRMWARE UPDATES ON A GPU-AS-A-SERVICE CLOUD

(71) Applicant: DELL PRODUCTS L.P., Round Rock, TX (US)

(72) Inventors: Ankit Singh, Bangalore (IN); Deepaganesh Paulraj, Bangalore (IN)

(21) Appl. No.: 18/158,585

(22) Filed: Jan. 24, 2023

(51) Int. Cl. G06F 8/65; G06F 21/57

(52) U.S. Cl. CPC G06F 8/65; G06F 21/572

(57) ABSTRACT

An information handling system includes a processor and a GPU baseboard. The GPU baseboard includes a plurality of GPUs. Each GPU is coupled to the processor by an associated external interface, and is coupled together by an internal interface. One of the GPUs is configured to receive a GPU firmware update instruction from the processor via the associated external interface, to execute the GPU firmware update instruction to update a GPU firmware for the particular GPU, and to forward the GPU firmware update instruction to the remaining GPUs via the internal interface.

### FIELD OF THE DISCLOSURE

This disclosure generally relates to information handling systems, and more particularly relates to providing parent-child GPU firmware updates on a GPU-as-a-Service (GPUaaS) cloud.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a processor and a GPU baseboard. The GPU baseboard may include a plurality of GPUs. Each GPU may be coupled to the processor by an associated external interface, and may be coupled together by an internal interface. One of the GPUs may be configured to receive a GPU firmware update instruction from the processor via the associated external interface, to execute the GPU firmware update instruction to update a GPU firmware for the particular GPU, and to forward the GPU firmware update instruction to the remaining GPUs via the internal interface.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an infrastructure-as-a-service (IaaS) system according to an embodiment of the current disclosure:

FIG. 2 is a block diagram of a graphic processing unit (GPU) IaaS system according to an embodiment of the current disclosure: and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures as needed or desired.

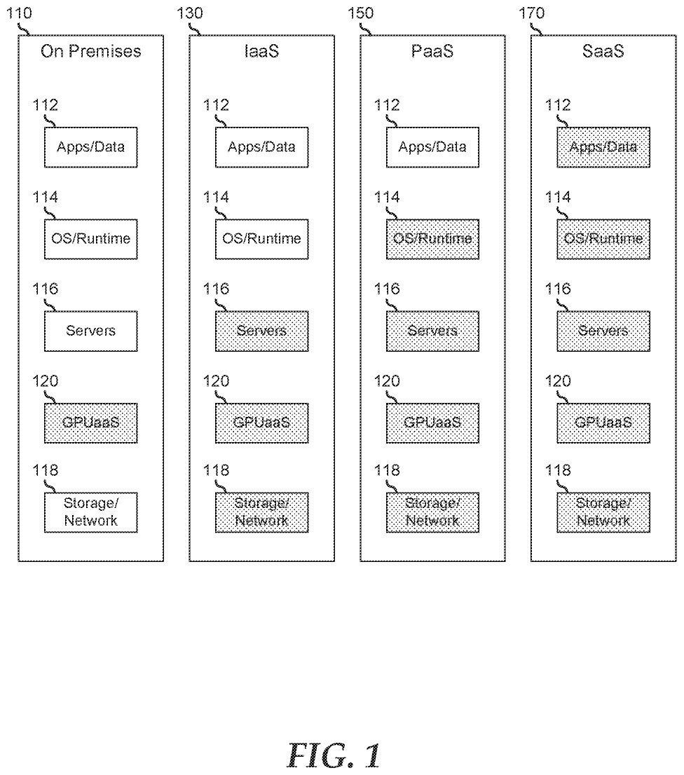

FIG. 1 illustrates various as-a-service (XaaS) systems 110, 130, 150, and 170. In this regard, XaaS systems 110, 130, 150, and 170 represent service-oriented processing architectures that provide various resources as virtualized computing resources to subscribers who can select the resources needed for their particular computing needs, without having to monitor, manage, or maintain the actual resources in a subscriber-controlled environment. In particular, various elements of each of XaaS systems 110, 130, 150, and 170 are monitored, managed, and maintained by a third party at a remote location from the subscribers, and are accessed via a cloud-based resources, as described further below. As illustrated, the resources of each of XaaS systems 110, 130, 150, and 170 that are under the direct control of the subscribers are illustrated without any shading of the resources, while the resources that are monitored, managed, and maintained by the remote provider are illustrated as shaded resources.

It has been understood by the inventors of the current disclosure that computing usage models are currently trending toward the extensive use of graphics processing units (GPUs) for such processing workloads as image rendering, 3D modeling and animation, artificial intelligence and machine learning processing, and the like. Additionally, the use of parallel processing with GPUs provides greater processing capacities for such workloads. In this regard, each of XaaS systems 110, 130, 150, and 170 share a common architectural feature in that each of the XaaS systems includes a pooled graphics processing unit (GPU) resource that is monitored, managed, and maintained by the remote provider. The pooled GPU resources will henceforth be referred to a GPU-as-a-Service (GPUaaS).

XaaS system 110 represents an on-premises computing architecture where the applications and data (henceforth “applications”) 112, the operating system (OS), middleware, and runtime services (henceforth “OS/runtime services”) 114, the servers and server virtualization services (henceforth “servers”) 116, and storage and network resources 118, are monitored, managed, and maintained by the subscriber at a subscriber premises. Here, only the use of GPUaaS 120 is provided to the subscriber as cloud-based resources. XaaS system 130 represents an infrastructure-as-a-service (IaaS) system, where, in addition to GPUaaS 120, servers 116 and storage and network resources 118 are provided to the subscriber as cloud-based services, and applications 112 and OS/runtime services 114 are monitored, managed, and maintained by the subscriber. XaaS system 150 represents a platform-as-a-service (PaaS) system, where only the applications 112 are monitored, managed, and maintained by the subscriber, and OS/runtime services 114, servers 116, storage and network resources 118, and GPUaaS 120 are provided as cloud-based resources. Finally, XaaS system 170 represents a Software-as-a-Service (SaaS) system, where none of the resources are monitored, managed, or maintained by the subscriber, but applications 112, OS/runtime services 114, servers 116, storage and network resources 118, and GPUaaS 120 are all provided as cloud-based resources. The details of XaaS systems are known in the art and will not be further described herein, except as may be needed to illustrate the current embodiments.

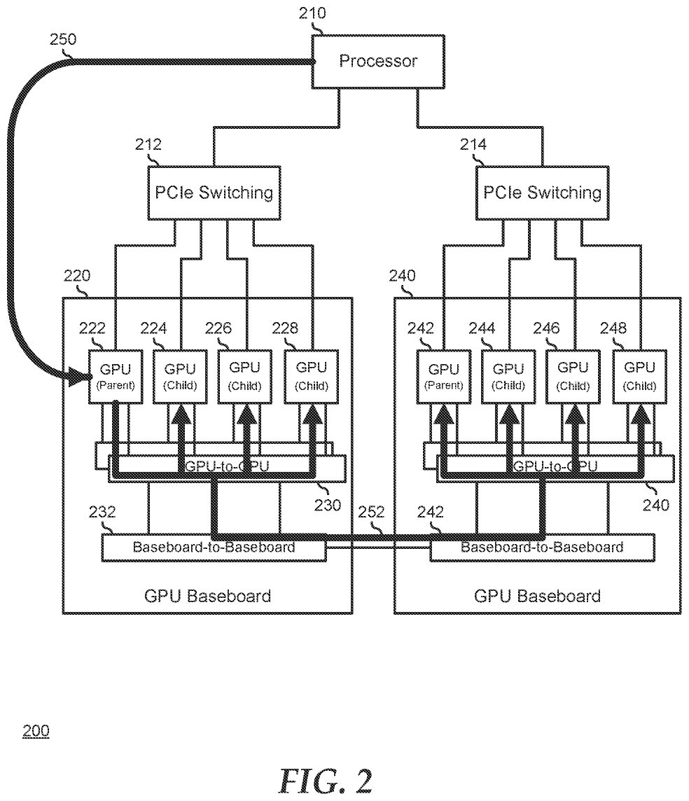

FIG. 2 illustrates a GPUaaS system 200 similar to GPUaaS system 120. GPUaaS system 200 includes a processor 210, PCIe switching networks 212 and 214, and GPU baseboards 110 and 240. GPU baseboards 220 and 240 represent highly parallelized processing units that provide for clustering of multiple separate GPUs and the easy interconnection between the GPU baseboards. In this regard, GPU baseboard 220 is illustrated as including four (4) GPUs 222, 224, 226, and 228 that are interconnected by two (2) GPU-to-GPU interfaces 230. Similarly, GPU baseboard 240 is illustrated as including four (4) GPUs 242, 244, 246, and 248 that are interconnected by two (2) GPU-to-GPU interfaces 250. GPU-to-GPU interface 230 is connected to a baseboard-to-baseboard interface 232, and GPU-to-GPU interface 250 is connected to a baseboard-to-baseboard interface 252. Here, by connecting baseboard-to-baseboard interfaces 232 and 252, the parallel processing of data is extendable across GPU baseboard 220 and GPU baseboard 240.

GPU baseboards 220 and 240 may represent GPU cluster products that are provided by a particular manufacturer, or that are custom designed by an operator of GPUaaS system 200, as needed or desired. For example, GPU baseboards 220 and 240 may represent GPU cluster products from NVIDIA, AMD, Intel, Apple, or another manufacturer, as needed or desired. Here, the nature of interfaces 230, 232, 250, and 252 may be determined in accordance with the particular manufacturer of GPU baseboards 220 and 240, as needed or desired. For example, interfaces 230, 232, 250, and 252 may represent interfaces that are in conformance with an open interface standard, such as PCIe interfaces, or may represent proprietary interfaces, such as NVIDIA NV-Switch and NV-Link or other proprietary interfaces, as needed or desired.

Processor 210 represents a general purpose processor associated with GPUaaS system 200 that coordinates the processing activities of the GPUaaS system, and interfacing with a data communication network that is connected to the subscribers of the GPUaaS system. In particular, processor 210 operates to receive processing data and instructions from subscribers to GPUaaS system 200, to distribute the data to GPUs 222, 224, 226, 228, 242, 244, 246, and 248 through PCIe switches 212 and 214, initiate processing by the GPUs based upon the received instructions, to receive the resulting data from the GPUs, and return the resulting data to the subscribers. The details of data processing on clustered GPUs and of providing GPUaaS systems are known in the art and will not be further described herein, except as may be needed to illustrate the current embodiments.

It has been understood by the inventors of the current disclosure that the use of GPU baseboards with multiple GPUs and the ability to directly connect the GPU baseboards to each other through baseboard-to-baseboard interfaces has greatly improved the scalability and processing capacity for GPUaaS systems. However, each individual GPU in a GPU baseboard typically maintains its own version of the GPU firmware. As such, when a GPU firmware update is required, a processor of the GPUaaS system typically needs to perform a GPU firmware update on each individual GPU independently from the other GPUs in the cluster. In this case, the processing resources of the GPUaaS system can be hampered from performing other processing tasks, such as receiving and responding to subscriber processing requests, when a GPU firmware update is required. Considering that a typical GPU cluster in a GPUaaS system may include hundreds of GPUs, this processing overhead can cause a considerable performance impact to the GPUaaS system. Moreover, GPU firmware version control must be strictly maintained to ensure that all GPUs in the cluster are operating with the same GPU firmware version.

In a particular embodiment, GPUaaS system 200 operates to reduce the processing overhead on processor 210 for performing GPU firmware updates on GPUs 222, 224, 226, 228, 242, 244, 246, and 248. In particular, GPUaaS system 200 utilizes GPU-to-GPU interfaces 230 and 250, and baseboard-to-baseboard interfaces 232 and 252 to propagate GPU firmware updates between GPUs 222, 224, 226, 228, 242, 244, 246, and 248. Here, one of GPUs 222, 224, 226, 228, 242, 244, 246, or 248 is designated as a “parent” GPU (here shown as GPU 222), and the other GPUs are designated as “child” GPUs (here shown as GPUs 224, 226, 228, 242, 244, 246, and 248). Then, in and exemplary case, parent GPU 222 can receive a GPU firmware update command 250 from processor 210, can implement the GPU firmware update command on itself, and can propagate the GPU firmware update command 252 to child GPUs 224, 226, 228, 242, 244, 246, and 248 over GPU-to-GPU interfaces 230 and 250, and baseboard-to-baseboard interfaces 232 and 252, and each child GPU can implement the GPU firmware update on itself.

Assume that processor 210 initiates a GPU firmware updates on an individual one of GPUs 222, 224, 226, 228, 242, 244, 246, and 248 by issuing a “GPU firmware update” command to the target GPU. In a particular embodiment, a cluster-based GPU firmware update is initiated by the “GPU firmware update” command targeted to the parent GPU (e.g., GPU 222), and the parent GPU then propagates the “GPU firmware update” command to the child GPUs GPUs (e.g., GPUs 224, 226, 228, 242, 244, 246, and 248) over GPU-to-GPU interfaces 230 and 250, and baseboard-to-baseboard interfaces 232 and 252 in response to receiving the “GPU firmware update” command. In this embodiment, parent GPU 222 will be understood to include a listing of child GPUs 224, 226, 228, 242, 244, 246, and 248, and any other child GPUs over which the parent GPU has jurisdiction, and processor 210 does not need to have any particular modification to perform the cluster-based GPU firmware update, but merely needs to target a “GPU firmware update” command to a parent GPU. The parent GPU will then propagate the “GPU firmware update” command automatically to the listed child GPUs. Further, in this embodiment, the designation of “parent GPU” may be pre-determined, such as where a first GPU in a GPU baseboard is designated as the “parent GPU,” or the designation may be randomly ascribed, as needed or desired. An example of random designation may include where a GPU baseboard-level firmware or initialization process operates to randomly designate the parent GPU, or where a first GPU of a cluster of GPUs to receive a “GPU firmware update” command assumes the roll of “parent GPU” for the particular firmware update version. In this latter case, a processor may target the “GPU firmware update” command to a particular GPU that is currently not processing data or is otherwise more lightly loaded than the other GPUs in the cluster.

In another embodiment, processor 210 implements a “GPU-cluster firmware update” command in addition to the “GPU firmware update” command. Here, a “parent GPU” will respond to the “GPU firmware update” command by only implements the GPU firmware update on itself, but will respond to the “GPU-cluster firmware update” command by propagating the GPU firmware update to the child GPUs as described above. In a first case, GPU baseboard 220 will include a listing of child GPUs 224, 226, 228, 242, 244, 246, and 248, and any other child GPUs over which the parent GPU has jurisdiction, as described above, and the parent GPU can be designated as described above. In another case, the “GPU-cluster firmware update” command includes the listing of child GPUs 224, 226, 228, 242, 244, 246, and 248, and any other child GPUs over which the parent GPU is to have jurisdiction. In this case, there may be no need to separately ascribe a “parent GPU,” and any one of the GPUs that receives the “GPU-cluster firmware update” command then operates to propagate the GPU firmware update to the listed GPUs. In this way, a separate designation of a “parent GPU” may not be necessary, and processor 210 can provide the initial “GPU-cluster firmware update” command to a particular GPU that is currently not processing data or is otherwise more lightly loaded than the other GPUs in the cluster.

Further, this embodiment may provide a great deal of flexibility between the time it takes for a single “parent GPU” to propagate a firmware update to all of the GPUs in a cluster, and the resource load on processor 210. Consider that issuing a single “GPU-cluster firmware update” command to a single “parent GPU” may result in a long GPU firmware update process, but would result in a minimum level of direct interaction between processor 210 and GPUs 222, 224, 226, 228, 242, 244, 246, and 248 for GPU firmware updates. On the other hand, being able to include the “child GPU” listing in the “GPU-cluster firmware update” command permits processor 210 to evaluate a trade-off between the number of “GPU-cluster firmware update” commands issued and the time needed to implement the GPU firmware update. For example, issuing two (2) “GPU-cluster firmware update” commands may result in a halving of the time needed to implement the GPU firmware update, issuing three (3) “GPU-cluster firmware update” commands may result in cutting the time needed to implement the GPU firmware update in thirds, etc.

In a particular embodiment, each of child GPUs 224, 226, 228, 242, 244, 246, and 248 send their update status to parent GPU 222, and the parent GPU sends a consolidated update status to processor 210. In a particular case, when the consolidated update status indicates that the GPU firmware update failed on any of GPUs 222, 224, 226, 228, 242, 244, 246, and 248, processor 210 operates to provide a “GPU firmware update” instruction targeted to the GPUs that failed the GPU-cluster firmware update. In another case, processor 210 operates to restrict the GPUs that failed the GPU-cluster firmware update from acting as the parent GPU. In another case, processor 210 operates to isolate the GPUs that failed the GPU-cluster firmware update from processing further subscriber processing requests until such time as the affected GPUs are successfully updated, or the affected GPUs are otherwise fixed or debugged.

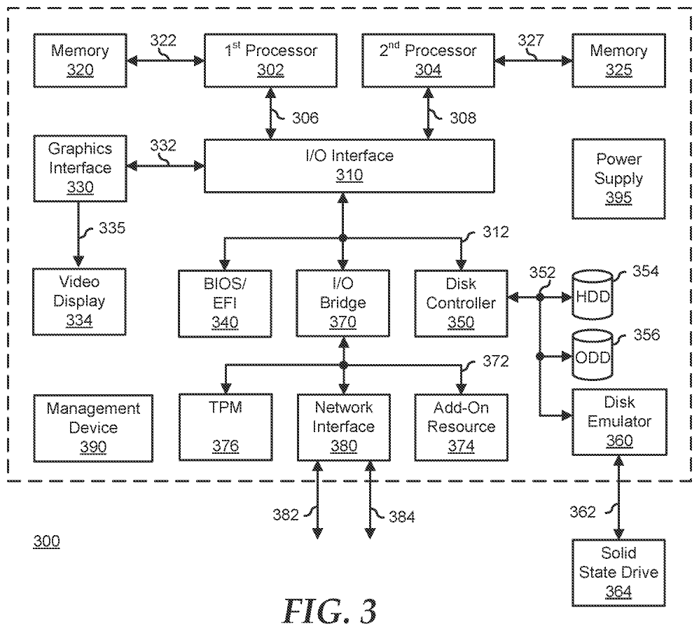

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320 and 325, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 335 to a video display 334. In a particular embodiment, information handling system 300 includes separate memories that are dedicated to each of processors 302 and 304 via separate memory interfaces. An example of memories 320 and 325 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on a separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 includes a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a processor; and
a first graphics processing unit (GPU) baseboard including a plurality of first GPUs, each first GPU being coupled to the processor by an associated first external interface, and being coupled together by a first internal interface;
wherein a particular one of the first GPUs is configured to receive a GPU firmware update instruction from the processor via the associated first external interface, to execute the GPU firmware update instruction to update a GPU firmware for the particular first GPU, and to forward the GPU firmware update instruction to the remaining first GPUs via the first internal interface.

2. The information handling system of claim 1, wherein each remaining first GPU is configured to update the GPU firmware for each particular remaining first GPU.

3. The information handling system of claim 2, further comprising:
a second GPU baseboard including a plurality of second GPUs, each second GPU being coupled to the processor by an associated first external interface and being coupled together by a second internal interface, the first internal interface being coupled to the second internal interface by a second external interface:
wherein the particular the first GPUs is further configured forward the GPU firmware update instruction to the second GPUs via the second external interface and the second internal interface.

4. The information handling system of claim 3, wherein each second GPU is configured to update the GPU firmware for the particular second GPU.

5. The information handling system of claim 4, wherein the particular first GPU is designated as a parent GPU and the remaining first GPUs and all of the second GPUs are designated as child GPUs.

6. The information handling system of claim 5, wherein the processor is configured to provide the GPU firmware update instruction to the particular first GPU based upon the particular first GPU being designated as the parent GPU.

7. The information handling system of claim 6, wherein the remaining first GPUs and all of the second GPUs are designated as child GPUs based upon a GPU list.

8. The information handling system of claim 3, wherein the first external interfaces are Peripheral Component Interconnect-Express interfaces.

9. The information handling system of claim 8, wherein the first and second internal interfaces are NVIDIA NVSwitch interfaces.

10. The information handling system of claim 9, wherein the second external interface is a NVIDIA NVLink interfaces.

11. A method, comprising:
coupling a processor to a first graphics processing unit (GPU) baseboard including a plurality of first GPUs, each first GPU being coupled to the processor by an associated first external interface and being coupled together by a first internal interface;
receiving, by a particular one of the first GPUs, a GPU firmware update instruction from the processor via the associated first external interface;
executing, by the particular first GPU, the GPU firmware update instruction to update a GPU firmware for the particular first GPU; and
forwarding, by the particular first GPU, the GPU firmware update instruction to the remaining first GPUs via the first internal interface.

12. The method of claim 11, further comprising updating, by each remaining first GPU, the GPU firmware for each particular remaining first GPU.

13. The method of claim 12, further comprising:
coupling the processor to a second GPU baseboard including a plurality of second GPUs, each second GPU being coupled to the processor by an associated first external interface and being coupled together by a second internal interface, and the first internal interface being coupled to the second internal interface by a second external interface; and
forwarding, by the particular first GPU, the GPU firmware update instruction to the second GPUs via the second external interface and the second internal interface.

14. The method of claim 13, further comprising updating, by each second GPU, the GPU firmware for each particular second GPU.

15. The method of claim 14, further comprising:
designating the particular first GPU as a parent GPU; and
designating the remaining first GPUs and all of the second GPUs are designated as child GPUs.

16. The method of claim 15, further comprising providing, by the processor, the GPU firmware update instruction to the particular first GPU based upon the particular first GPU being designated as the parent GPU.

17. The method of claim 16, wherein the remaining first GPUs and all of the second GPUs are designated as child GPUs based upon a GPU list.

18. The method of claim 13, wherein the first external interfaces are Peripheral Component Interconnect-Express interfaces.

19. The method of claim 18, wherein the first and second internal interfaces are NVIDIA NVSwitch interfaces, and wherein the second external interface is a NVIDIA NVLink interfaces.

20. A graphics processing unit (GPU) baseboard, comprising:
a plurality of GPUs, each GPU being coupled to a processor by an associated external interface; and
an internal interface coupled to each of the GPUs;
wherein a particular one of the first GPUs is configured to receive a GPU firmware update instruction from the processor via the associated external interface, to execute the GPU firmware update instruction to update a GPU firmware for the particular first GPU, and to forward the GPU firmware update instruction to the remaining first GPUs via the internal interface.
